(19) United States
(12) Patent Application Publication
(10) Pub. No.: US 2005/0264601 A1
(43) Pub. Date: Dec. 1, 2005

(54) Inkjet printer

(75) Inventor: Jin-Ho Park, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/094,602

(22) Filed: Mar. 31, 2005

(30) Foreign Application Priority Data
May 25, 2004 (KR) 2004-0037256

(51) Int. Cl. B41J 2/165

(52) U.S. Cl. 347/33

(57) ABSTRACT

An inkjet printer includes a printhead containing a nozzle portion having a length corresponding to a width of a paper sheet. A moving block is configured to move along a longitudinal direction of the nozzle portion. A cleaning unit has one or more blades to wipe off waste ink by contacting the nozzle portion. The cleaning unit is mounted in the moving block. Accordingly, the nozzle portion is effectively cleaned, and thus deterioration of the printing quality due to waste ink may be prevented.

This application claims the benefit under 35 U.S.C. 119(a) of Korean Patent Application No. 10-2004-0037256, filed on May 25, 2004, the entire disclosure of which is hereby incorporated by reference.

### BACKGROUND OF THE INVENTION

1. Field of the Invention

The present invention relates to an inkjet printer. More particularly, the present invention relates to an inkjet printer capable of cleaning an ink ejection nozzle portion therein.

2. Description of the Related Art

An inkjet printer is a device for producing images by ejecting ink droplets onto a paper sheet from a printhead. The printhead is disposed at a predetermined distance from the paper sheet and reciprocates in a direction perpendicular to movement of the paper. The printhead includes a nozzle portion having a plurality of nozzles. Old non-ejected ink droplets, hardened deposits formed by dried ink, and air borne particulates accumulate on the surface of the nozzle portion and around the nozzles when ink droplets are ejected during printing operations. Thus, the direction of ink ejection is altered and printing quality deteriorates.

Devices for cleaning nozzle portions are disclosed in Japanese Patent Publication Nos. 2-113949, 5-092576, 11-254692, 15-063021, the entire disclosures of which are hereby incorporated by reference. In these publications, a length of a nozzle portion is typically less than 1 inch in a direction of a width of the paper sheet. A device having a nozzle scrubs away old ink droplets, hardened deposits, and particulates accumulated on the nozzle portion by reciprocating a wiper. The wiper is a little longer than the nozzle portion in a direction of paper movement. The wiper is repeatedly transferred in the paper movement direction.

Recently, instead of using a printhead which reciprocates along a width direction of a paper sheet, high-speed printing has been performed using a printhead having a nozzle portion of a length corresponding to a width of a paper sheet. In such an inkjet printer, the printhead is substantially fixed and only a paper sheet is transferred. Accordingly, a driving device of the inkjet printer is relatively simple and allows high-speed printing to be performed. A length of the nozzle portion in such inkjet printer is, for example, about 210 mm and corresponds to A4 sized paper when a printing margin of the paper in a width direction is not considered. Therefore, there is a need for a specific device to clean a nozzle portion.

Accordingly, there is a need for an improved inkjet printer to prevent deterioration of printing quality. The inkjet printer has a cleaning unit which moves along a longitudinal direction of a nozzle portion. The nozzle portion has a length corresponding to a width of a paper sheet

### SUMMARY OF THE INVENTION

An aspect of the present invention is to solve at least the above problems and/or disadvantages and to provide at least the advantages described below. Accordingly, an aspect of the present invention is to provide an inkjet printer including a printhead containing a nozzle portion having a length corresponding to a width of a paper sheet and a device to clean the printhead.

According to an aspect of the present invention, there is provided an inkjet printer including a printhead containing a nozzle portion having a length corresponding to a width of a paper sheet. A moving block moves along a longitudinal direction of the nozzle portion. A cleaning unit has one or more blades to wipe off waste ink from the nozzle portion. The cleaning unit is mounted on the moving block.

The cleaning unit may include a plurality of the blades and rotates in a longitudinal direction of the nozzle portion. The inkjet printer may further include a scraper to remove waste ink from the blades. The scraper is formed on the moving block.

It is preferable that the nozzle portion may include at least one row of nozzle sections arranged in a transferring direction of the paper sheet.

It is also preferable that the cleaning unit may include at least one row of blades corresponding to each of the nozzle sections. A plurality of the blades may be arranged radially in each of the rows, and the cleaning unit is rotated in a longitudinal direction of the nozzle portion.

The blade may have one or more contacting portions to contact one of the nozzle sections, and the cleaning unit may include a plurality of blades and rotates in a longitudinal direction of the nozzle portion. When more than two contact portions are formed, each of the contact portions may correspond to each of the nozzle sections that are not adjacent to each other.

At least one row of scrapers to remove the waste ink preferably corresponds to the at least one rows of blades.

A plurality of the cleaning units may be disposed apart from each other in a longitudinal direction of the nozzle portion.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, and features, and advantages of certain embodiments of the present invention will be more apparent from the following description taken in conjunction with the accompanying drawings, in which:

FIG. 1 is a perspective view of an inkjet printer in accordance with a first embodiment of the present invention;

FIGS. 2A, 2B, 3A and 3B are examples illustrating a structure of a nozzle portion of the inkjet printer of FIG. 1;

FIG. 4 shows in detail a perspective view of part E of FIG. 1;

FIG. 5 is a sectional view taken along line I′-I′ of FIG. 4;

FIG. 6 is a perspective view of an inkjet printer in accordance with a second embodiment of the present invention;

FIG. 7 is a sectional view taken along line II′-II′ of FIG. 6;

FIGS. 8-10 show working operations of the inkjet printer illustrated in FIG. 6;

FIG. 11 is a perspective view of an inkjet printer in accordance with a third embodiment of the present invention;

FIG. 12 is a perspective view of an inkjet printer in accordance with a fourth embodiment of the present invention;

FIG. 13 is a perspective view of an inkjet printer in accordance with a fifth embodiment of the present invention;

FIG. 14 is a perspective view of an inkjet printer in accordance with a sixth embodiment of the present invention;

FIG. 15 is a perspective view of an inkjet printer in accordance with a seventh embodiment of the present invention; and

FIG. 16 is a diagram showing areas that cannot be cleaned due to the cleaning unit illustrated in FIG. 13.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for conciseness.

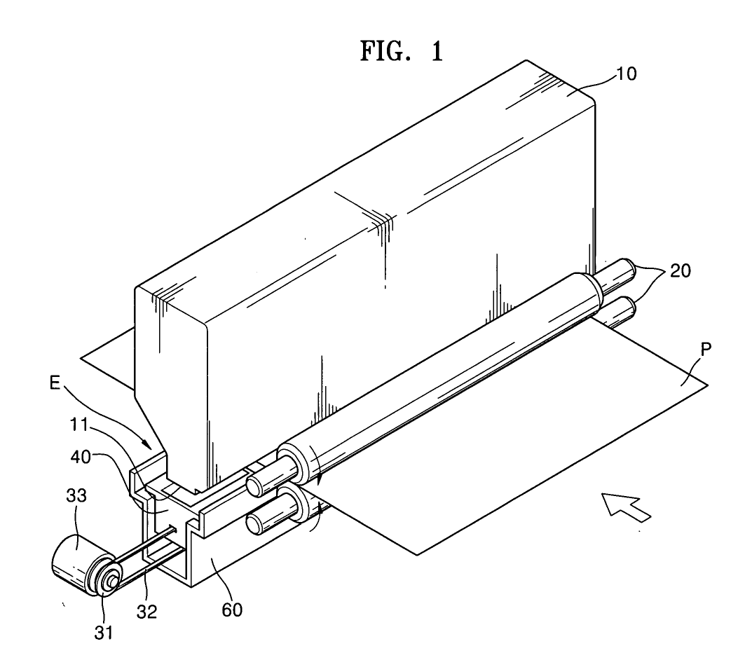

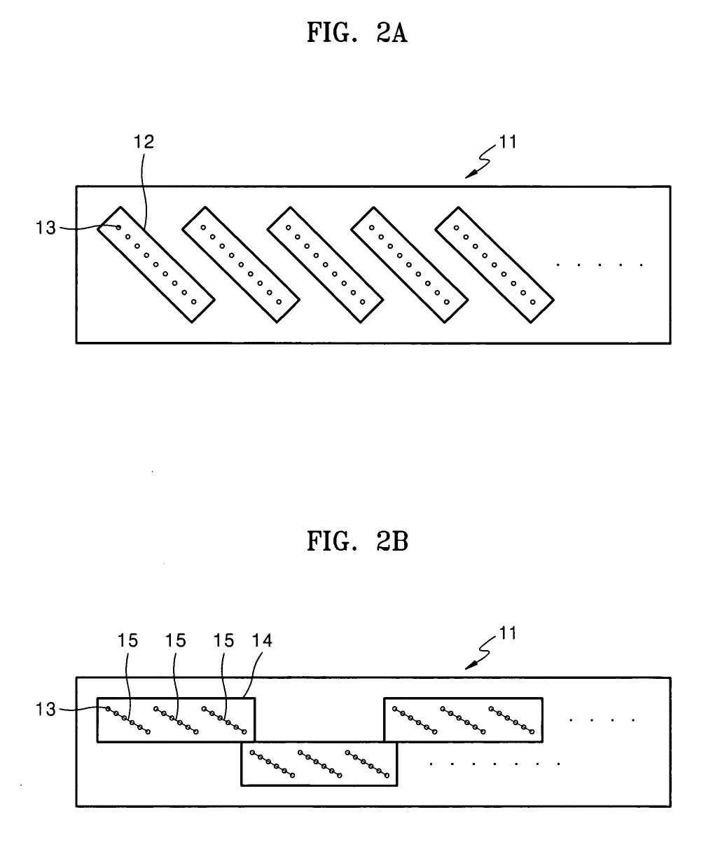

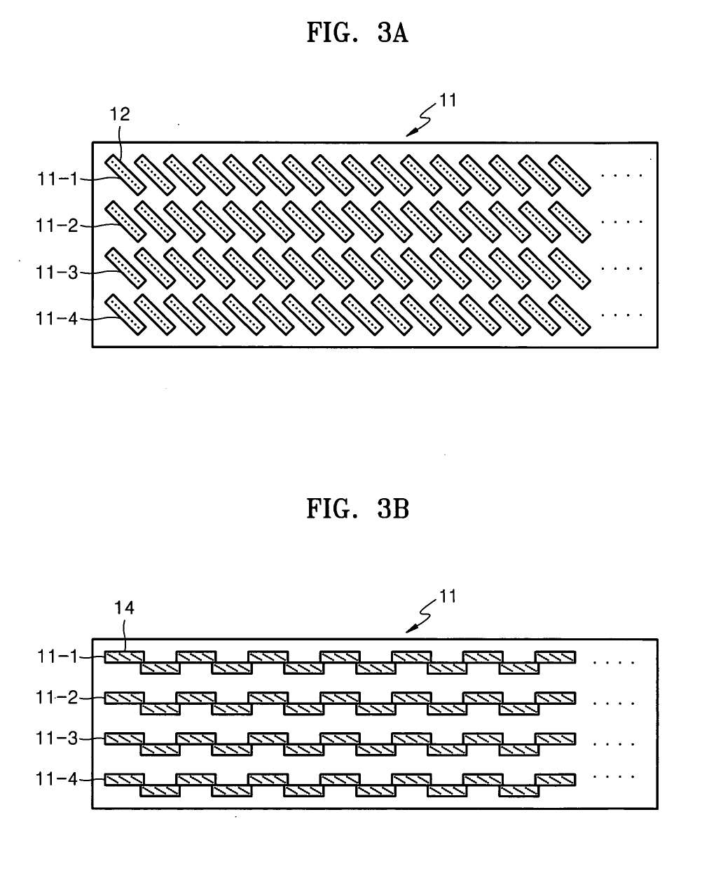

FIG. 1 is a perspective view of an inkjet printer in accordance with a first embodiment of the present invention. Referring to FIG. 1, a paper sheet P is transferred by a pair of rollers 20. The pair of rollers 20 are rotatably engaged with one other. A printhead 10 is placed above paper sheet P. The printhead 10 includes a nozzle portion 11 having a length corresponding to a width of the paper sheet P. FIGS. 2A, 2B, 3A and 3B are are exemplary embodiments of the nozzle portion 11; however, alternative suitable arrangements and constructions may be used. In nozzle portion 11 illustrated in FIG. 2A, nozzle plates 12 have a plurality of nozzles 13 linearly formed thereon which are inclined and arranged in a longitudinal direction of the nozzle portion. In the nozzle portion 11 illustrated in FIG. 2B, nozzle plates 14 have a plurality of rows of nozzles 15 obliquely formed thereon and are arranged in two rows in an alternating fashion. The nozzle portions illustrated in FIGS. 3A and 3B include four rows of nozzle sections 11-1, 11-2, 11-3 and 11-4 disposed in a moving direction of the paper sheet P. Each nozzle section 11-1, 11-2, 11-3 and 11-4 may eject ink of the same color or ink of different colors (e.g. cyan, magenta, yellow, and black).

The nozzle portions 11 illustrated in FIGS. 2A, 2B, 3A, and 3B are only exemplary and other suitable arrangements and constructions may be used. The printhead 10 prints an image on the paper sheet P. The printhead 10 prints an image by successively ejecting ink from nozzles 13 at fixed positions onto the paper sheet P when the paper sheet P is transferred by the pair of rollers 20.

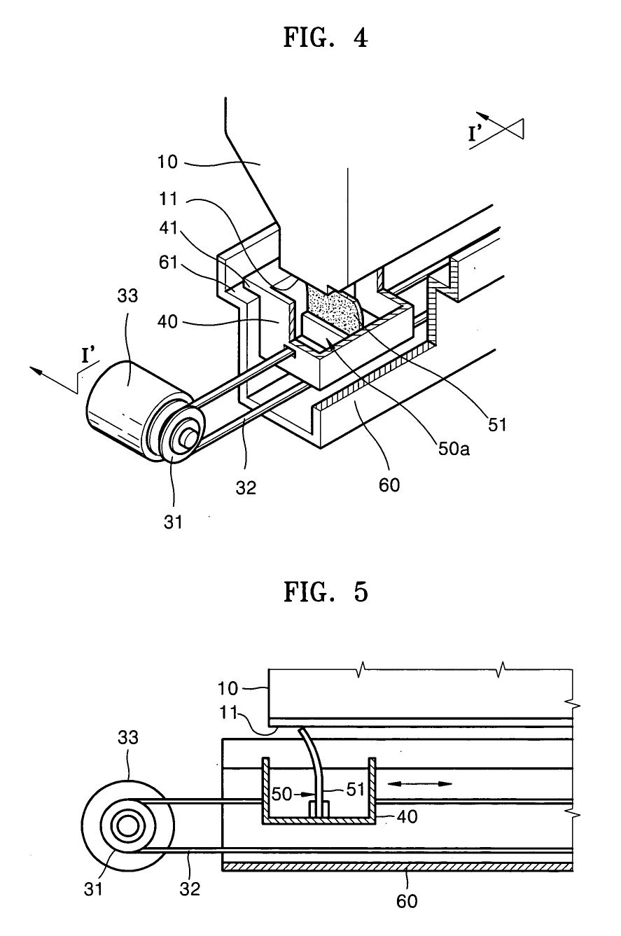

FIG. 4 is a perspective view illustrating in detail part E of FIG. 1. FIG. 5 is a sectional view taken along line I′-I′ of FIG. 4. Referring to FIGS. 4 and 5, a belt 32 is supported by pulleys 31 and moves rotatably in a width direction of the paper sheet P. A drive motor 33 rotates the pulleys 31. A moving block 40 is mounted with a cleaning unit 50a. The cleaning unit 50a includes a blade 51 to elastically contact the nozzle portion 11. Preferably, elastic rubber is used for the blade 51; however, any suitable material may be used. The moving block 40 is connected to the belt 32. When the drive motor 33 rotates, the moving block 40 is transferred in a longitudinal direction of the nozzle portion 11. Both ends 41 of the moving block 40 are supported by rails 61 formed on a housing 60.

When cleaning the nozzle portion 11, the moving block 40 is rotatably transferred in a longitudinal direction of the nozzle portion 11 by the drive motor 33. Then, the blade 51 elastically contacts the nozzle portion 11 and cleans “waste ink” such as ink droplets, hardened deposits, and particulates residing on the surface of the nozzle portion 11.

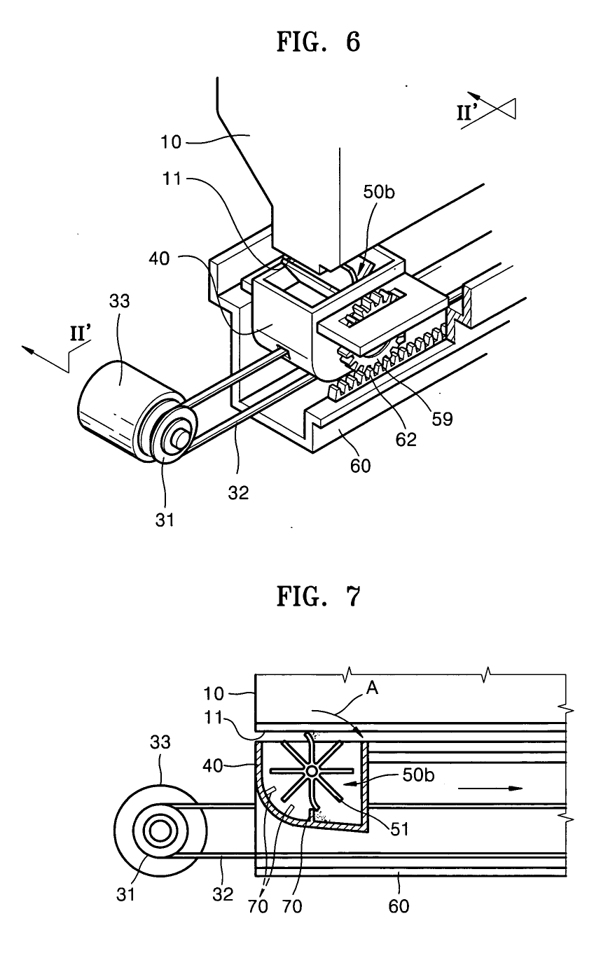

FIG. 6 is a perspective view of the inkjet printer in accordance with a second embodiment of the present invention. FIG. 7 is a sectional view taken along line II′-II′ of FIG. 6. Referring to FIGS. 6 and 7, a cleaning unit 50b includes a plurality of blades 51 arranged radially. The cleaning unit 50b rotates in a longitudinal direction of nozzle portion 11. The cleaning unit 50b is provided with pinions 59 which are engaged with rack gears 62 formed on housing 60. Accordingly, when the drive motor 33 is rotated, moving block 40 moves in a longitudinal direction of the nozzle portion 11. Here, the cleaning unit 50b rotates in the direction of arrow A. Then, a plurality of blades 51 elastically contact the nozzle portion 11 and clean waste ink residing on the nozzle portion 11.

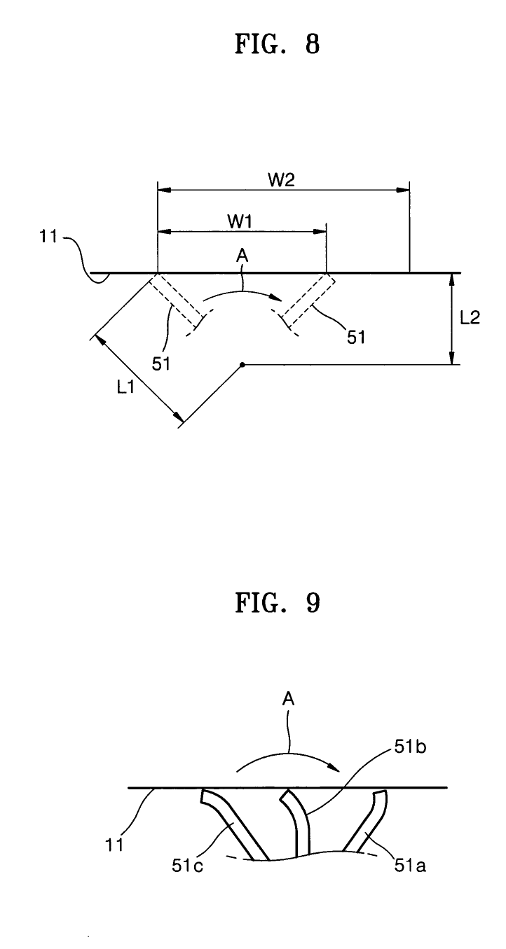

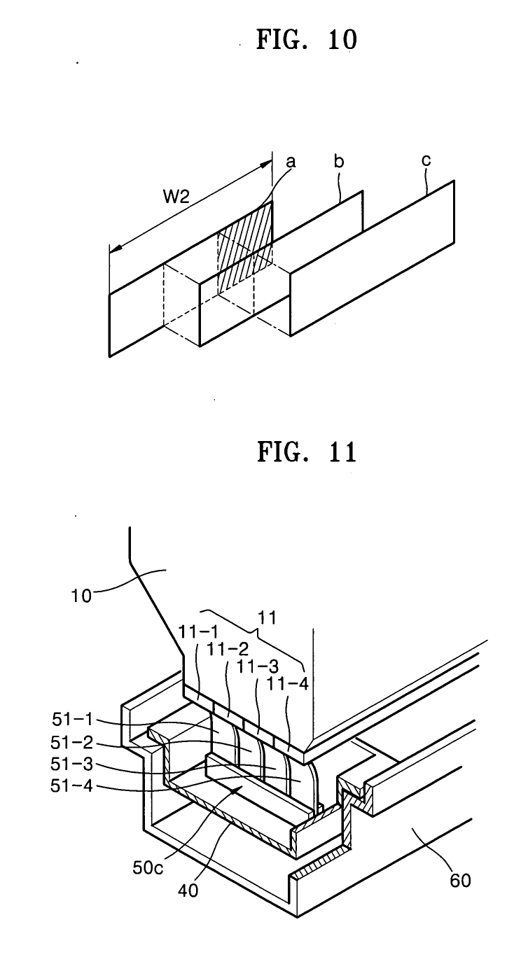

When the moving block 40 is moved once along a length direction of the nozzle portion 11, the nozzle portion 11 is wiped several times. Referring to FIG. 8, a length L1 of the blade 51 is longer than a distance L2 from the rotational center of the cleaning unit 50b to the nozzle portion 11. In a situation where the moving block 40 does not move and the cleaning unit rotates, one of the blades 51 would wipe the nozzle portion 11 along a length W1. However, actually, the blade 51 wipes the nozzle portion 11 along a length W2 which is longer than the length W1 when factoring in the moving speed of the moving block 40. Referring to FIG. 9, before one of the blades 51a is disconnected from the nozzle portion 11, blades 51b and 51c already contact the nozzle portion 11. Referring to FIG. 10, each of the blades 51a, 51b, and 51c wipe areas ‘a’, ‘b’ and ‘c’ overlapping one another and having a length W2. Herein, the part indicated by slant lines in the area ‘a’ is cleaned by the three blades 51a, 51b, and 51c. Accordingly, the nozzle portion 11 may be wiped three times during one transversal motion of the moving block 40. The number of times of wiping the nozzle portion 11 may vary by regulating the number of the blades 51 and the moving speed of the moving block 40. The moving speed of the moving block 40 is adjusted depending on how many times the driving motor 33 is rotated.

The waste ink removed from the nozzle portion 11 is generally stuck to an end of the blade 51. When the blade 51 contacts the nozzle portion 11, the waste ink clinging to the blade 51 may move and stick to the nozzle portion 11 again and often re-contaminates the nozzle portion 11. As illustrated in FIG. 7, a rib-shaped scraper 70 protrudes from the inside of the moving block 40 to prevent this problem. The scraper 70 contacts the rotating blade 51 to clean the waste ink from the blade 51. A plurality of scrapers 70 may also be formed as illustrated by dotted lines in FIG. 7.

FIG. 11 is a sectional view of an inkjet printer in accordance with a third embodiment of the present invention. Referring to FIG. 11, a nozzle portion 11 includes four rows of nozzle sections 11-1, 11-2, 11-3 and 11-4 as illustrated in FIGS. 3A and 3B. A cleaning unit 50c includes four rows of blades 51-1, 51-2, 51-3 and 51-4 which contact the nozzle sections 11-1, 11-2, 11-3 and 11-4, respectively. Accordingly, when moving block 40 moves along in a longitudinal direction of the nozzle portion 11, the blades 51-1, 51-2, 51-3 and 51-4 clean the nozzle sections 11-1, 11-2, 11-3 and 11-4, respectively.

The inkjet printer having such structure is effective when each of nozzle sections 11-1, 11-2, 11-3 and 11-4 ejects ink of different colors, such as, cyan, magenta, yellow, and black. Each blade 51-1, 51-2, 51-3 and 51-4 cleans the nozzle sections 11-1, 11-2, 11-3 and 11-4 individually, thus preventing ink of different colors from being mixed. For example, the nozzle sections 11-2 ejecting magenta ink may be prevented from being stained with cyan ink wiped off from the nozzle section 11-1.

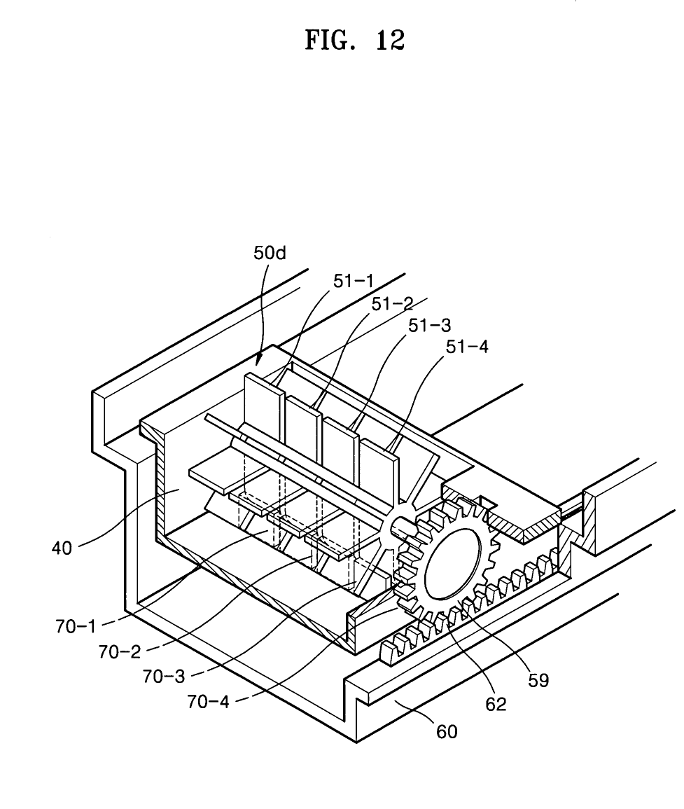

FIG. 12 is a sectional view of an inkjet printer in accordance with a fourth embodiment of the present invention. A nozzle portion 11 includes four rows of nozzle sections 11-1, 11-2, 11-3 and 11-4, for example, as illustrated in FIGS. 3A and 3B. A cleaning unit 50d is mounted on a moving block 40 as illustrated in FIG. 6. The cleaning unit 50d is moved by belt 32 and the drive motor 33 in a longitudinal direction of the nozzle portion 11. The cleaning unit 50d is provided with pinions 59, which are engaged with rack gears 62 formed on housing 60. When the drive motor 33 rotates, the moving block 40 moves in a longitudinal direction of the nozzle portion 11. The cleaning unit 50d also rotates in a longitudinal direction of the nozzle portion 11. Referring to FIG. 12, the cleaning unit 50d includes four rows of blades 51-1, 51-2, 51-3 and 51-4 to contact each nozzle section 11-1, 11-2, 11-3 and 11-4. The plurality of blades 51 are radially arranged in each row.

Accordingly, referring to FIGS. 6-10, as the moving block 40 is moved once in a longitudinal direction of the nozzle portion 11, each nozzle section 11-1, 11-2, 11-3 and 11-4 may be wiped several times. Also, an inkjet printer having such a structure prevents ink of different colors from mixing when each nozzle section thereof 11-1, 11-2, 11-3 and 11-4 ejects ink of different colors.

For removing waste ink stuck to the blades 51-1, 51-2, 51-3 and 51-4, the inkjet printer in accordance with exemplary embodiments of the present invention may further include the scraper 70 as illustrated in FIG. 7. Here, the four rows of scrapers 70-1, 70-2, 70-3, and 70-4 may be provided to correspond to the four rows of the blades 51-1, 51-2, 51-3 and 51-4. Each scraper 70-1, 70-2, 70-3, and 70-4 is preferably disposed apart from one another.

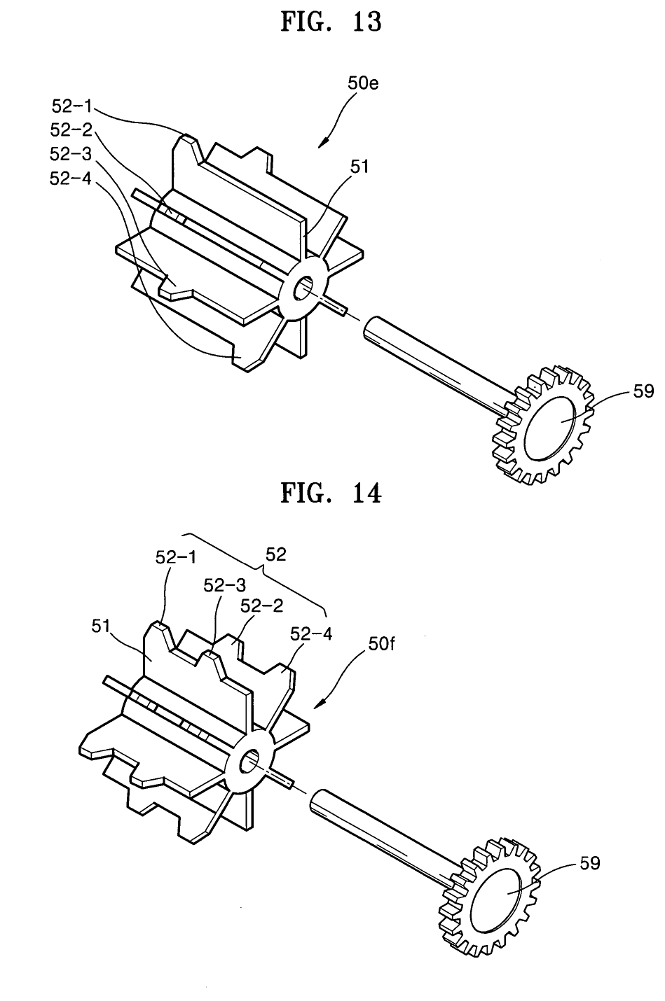

FIG. 13 is a sectional view of an inkjet printer in accordance with a fifth embodiment of the present invention. A nozzle section 11 includes four rows of nozzle sections 11-1, 11-2, 11-3 and 11-4 as, for example, illustrated in FIGS. 3A and 3B. A cleaning unit 50e is mounted on moving block 40 as shown in FIG. 6. The cleaning unit 50e is moved by belt 32 and drive motor 33 in a longitudinal direction of the nozzle portion 11. The cleaning unit 50e is provided with pinions 59, which are engaged with rack gears 62 formed on a housing 60. When the drive motor 33 rotates, the moving block 40 moves in a longitudinal direction of the nozzle portion 11. The cleaning unit 50e rotates in a longitudinal direction of the nozzle portion 11. Referring to FIG. 13, the cleaning unit 50e includes a plurality of blades 51 arranged radially therein. Each blade 51 includes one of contacting portions 52-1, 52-2, 52-3, and 52-4 contacts the nozzle sections 11-1, 11-2, 11-3, and 11-4.

Accordingly, as the moving block 40 moves in a longitudinal direction of the nozzle portion 11, each blade 51 cleans the nozzle sections 11-1, 11-2, 11-3 and 11-4 individually. Thus, ink of different colors may be prevented from being mixed when each nozzle section ejects different color ink droplets. If the number of the blades 51 is increased, the nozzle sections 11-1, 11-2, 11-3 and 11-4 may be wiped several times repeatedly during one transversal motion of the moving block 40.

FIG. 14 is a sectional view of an inkjet printer in accordance with a sixth embodiment of the present invention. In this embodiment, in comparison to the embodiment illustrated in FIG. 13, each blade 51 has two of the contacting portions 52-1, 52-2, 52-3, and 52-4. For example, the contacting portions 52-1 and 52-3 contact the nozzle sections 11-1 and 11-3. Additionally, the contacting portions 52-2 and 52-4 contact the nozzle sections 11-2 and 11-4 and are formed on each of the blades 51 alternatively. In this arrangement, two contacting portions may be disposed to contact a set of the nozzle sections 11-1, 11-3 and 11-2, 11-4 which are not adjacent to each other. Accordingly, the same effect as described with reference to FIG. 13 may be achieved.

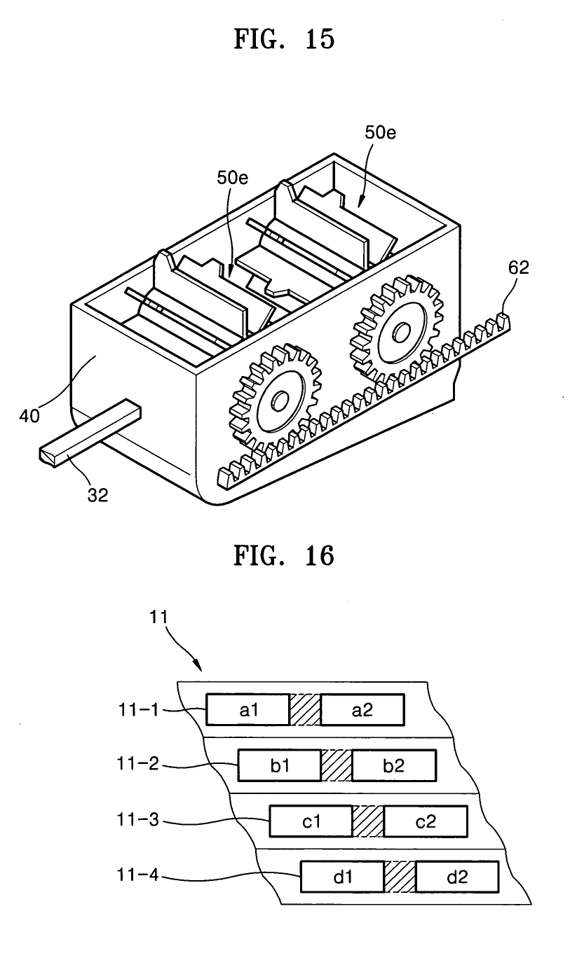

FIG. 15 is a sectional view of an inkjet printer in accordance with a seventh embodiment of the present invention. Referring to FIG. 15, a moving block 40 includes two cleaning units 50e arranged therein in a longitudinal direction of nozzle portion 11. This embodiment employs the cleaning units 50e illustrated in FIG. 13; however, the cleaning units illustrated in FIGS. 4, 6, 11, 12 and 14 may be used. Accordingly, when the moving block 40 is moved once, the nozzle portion 11 may be wiped several times.

The efficiency of the inkjet printer of the seventh embodiment is improved when the cleaning units 50e and 50f are installed therein. In the above embodiments, when enough blades 51 cannot be installed due to a narrow space or the rotation speed of the cleaning units 50e and 50f is not sufficiently fast compared with the moving speed of the moving block 40, an area that cannot cleaned may appear. FIG. 16 shows areas that cannot be cleaned when the cleaning unit 50e illustrated in FIG. 13 is used. Referring to FIG. 16, the blade 51 cleans the nozzle portion in the order of a1-b1-c1-d1-a2-b2-c2-d2. Here, if the rotation speed of the cleaning unit 50e is not sufficiently fast compared with the moving speed of the moving block 40, areas a1-a2, b1-b2, c1-c2, and d1-d2 that cannot be cleaned appear. To solve this problem, two cleaning units 50e and 50f are preferably provided.

The inkjet printers illustrated in FIGS. 13, 14 and 15 may further include a scraper 70 as illustrated in FIGS. 6 and 7. The scraper 70 wipes off waste ink stuck to the contacting portions 52. Here, as shown in FIG. 12, four rows of scrapers 70-1, 70-2, 70-3, and 70-4 may be provided to correspond to the four rows of the nozzle sections 11-1, 11-2, 11-3 and 11-4. Each of the scrapers 70-1, 70-2, 70-3 and 70-4 are preferably disposed apart from one another.

As described above, the inkjet printer in accordance with embodiments of the present invention have the following advantages:

First, the nozzle portion moves a cleaning unit along a longitudinal direction of the nozzle portion. Thus, the nozzle portion has a length corresponding to a width of a paper sheet and is effectively cleaned by the cleaning unit. Consequently, deterioration of printing quality is prevented.

Second, by disposing a plurality of the cleaning units or rotating the cleaning unit(s), the nozzle portion may be cleaned several times with one movement of the cleaning unit(s). Thus, cleaning time of the nozzle portion may be reduced.

Third, by providing a plurality of blades corresponding to a plurality of nozzle sections, ink of different colors may be prevented from being mixed.

Fourth, by including scraper(s), the removed waste ink cannot contaminate the nozzle portion again.

While the invention has been shown and described with reference to certain embodiments thereof, it will be understood by those skilled in the art that various changes in form and details may be made therein without departing from the spirit and scope of the invention as defined by the appended claims.

1. An inkjet printer comprising:
a printhead including a nozzle portion having a length corresponding to a width of a paper sheet;
a moving block being configured to move in a longitudinal direction of the nozzle portion;
a cleaning unit having at least one blade to wipe off waste ink by contacting the nozzle portion, the cleaning unit being mounted on the moving block.

2. The inkjet printer of claim 1, wherein the at least one blade is a plurality of blades, and the cleaning unit rotates in the longitudinal direction of the nozzle portion.

3. The inkjet printer of claim 2, further including a plurality of cleaning units disposed apart from one another in the longitudinal direction of the nozzle portion.

4. The inkjet printer of claim 2, further including:
a scraper to remove the waste ink from the plurality of blades by contact, the scraper being formed on the moving block.

5. The inkjet printer of claim 1, wherein the nozzle portion includes at least one row of nozzle sections arranged in a transferring direction of the paper sheet.

6. The inkjet printer of claim 5, wherein the at least one row of nozzle sections eject ink of different colors onto the paper sheet.

7. The inkjet printer of claim 5, wherein the at least one blade is a plurality of blades arranged in a row, the plurality of blades correspond to the at least one nozzle sections.

8. The inkjet printer of claim 7, wherein the plurality of blades and the cleaning unit are rotated in a longitudinal direction of the nozzle portion.

9. The inkjet printer of claim 8, further including a plurality of the cleaning units disposed apart from one another in a longitudinal direction of the nozzle portion.

10. The inkjet printer of claim 8, further including:
a scraper to remove the waste ink from the plurality of blade by contact, the scraper being formed on the moving block.

11. The inkjet printer of claim 10, further including at least one row of scrapers corresponding to the row of the plurality of blades.

12. The inkjet printer of claim 5, wherein the at least one blade has at least one contacting portion to contact the at least one nozzle sections, and the cleaning unit includes the at least one blade and rotates in a longitudinal direction of the nozzle portion.

13. The inkjet printer of claim 12, further including a plurality of the cleaning units disposed apart from one another in a longitudinal direction of the nozzle portion.

14. The inkjet printer of claim 12, wherein if the at least one contacting portion is formed as more than one contacting portion, each of the contacting portions corresponds to each of the at least one nozzle sections that are not adjacent to each other.

15. The inkjet printer of claim 12, further including:
a scraper to remove the waste ink by contacting the at least one contacting portion, the scraper being formed on the moving block.

16. The inkjet printer of claim 15, further including at least one row of scrapers corresponding to the at least one row of nozzle sections.

17. The inkjet printer of claim 1, further including a plurality of the cleaning units disposed apart from one another in a longitudinal direction of the nozzle portion.
